(19) United States
(12) Patent Application Publication
(10) Pub. No.: US 2011/0164133 A1
(43) Pub. Date: Jul. 7, 2011

(54) SURVEILLANCE SYSTEM

(75) Inventor: JEN-TSORNG CHANG, Tu-Cheng (TW)

(73) Assignee: HON HAI PRECISION INDUSTRY CO., LTD., Tu-Cheng (TW)

(21) Appl. No.: 12/853,564

(22) Filed: Aug. 10, 2010

(30) Foreign Application Priority Data
Jan. 4, 2010 (CN) 201010300025.5

(51) Int. Cl. H04N 7/18

(52) U.S. Cl. 348/143; 348/E07.085

(57) ABSTRACT

A surveillance system includes an image capturing device and an auxiliary light source. The image capturing device includes at least one image capturing module. The image capturing module includes an image sensor and a filter disposed on an object side of the image sensor. The visible light transmittance of the filter is higher than the near-infrared light transmittance of the filter. The auxiliary light source includes a near-IR emitter and a brightness sensor. The near-IR emitter is configured for emitting near-infrared light rays to illuminate a monitored area. The brightness sensor stores a predetermined brightness threshold and is configured for detecting the brightness value of the monitored area and sending a controlling signal to turn on the near-IR emitter when the brightness value is less than the brightness threshold.

### BACKGROUND

1. Technical Field

The present disclosure relates to a surveillance system.

2. Description of Related Art

Most current surveillance systems include a daytime filter and a night filter which are respectively used in daytime and at night for better image quality. To switch the filters, complicated driving mechanisms are required, thereby increasing size and cost of the surveillance systems.

Therefore, it is desirable to provide a surveillance system that can overcome the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a top view of a surveillance system, according to an exemplary embodiment.

FIG. 2 is a functional block diagram of the surveillance system of FIG. 1.

FIG. 3 is a cross-sectional view of the surveillance system, taken along the line III-III of FIG. 1.

FIG. 4 is a graph showing transmittance characteristics of a filter.

### DETAILED DESCRIPTION

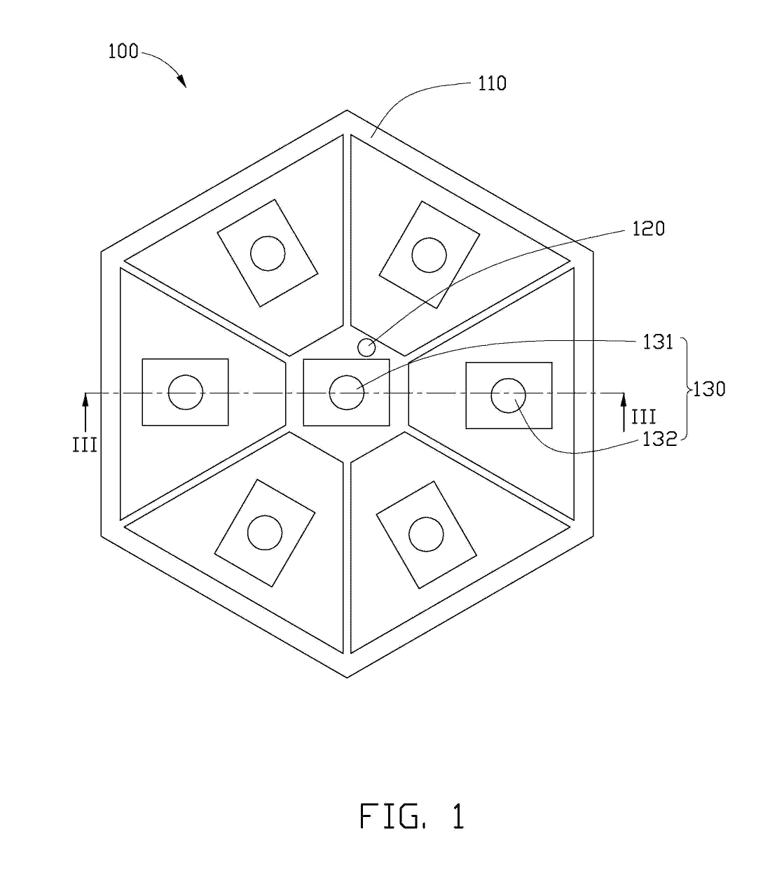

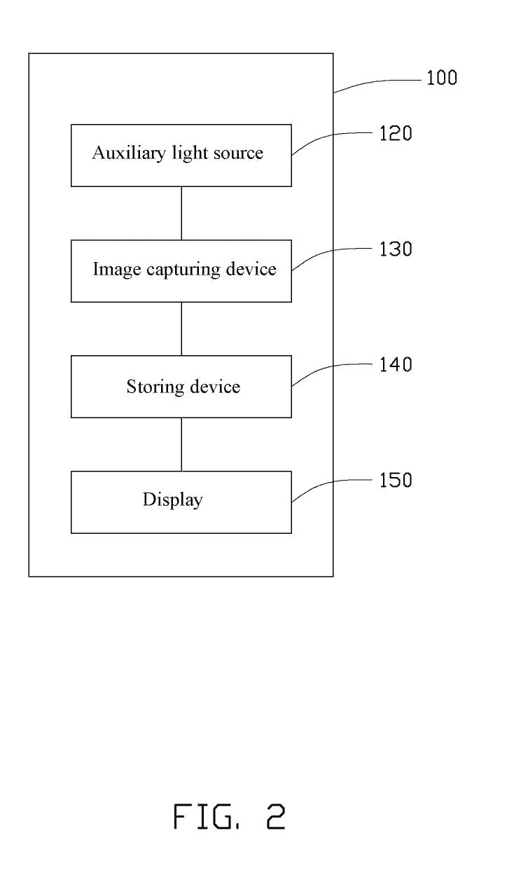

Referring to FIG. 1 and FIG. 2, a surveillance system 100, according to an exemplary embodiment, includes a casing 110, an auxiliary light source 120, an image capturing device 130, a storing device 140, and a display 150.

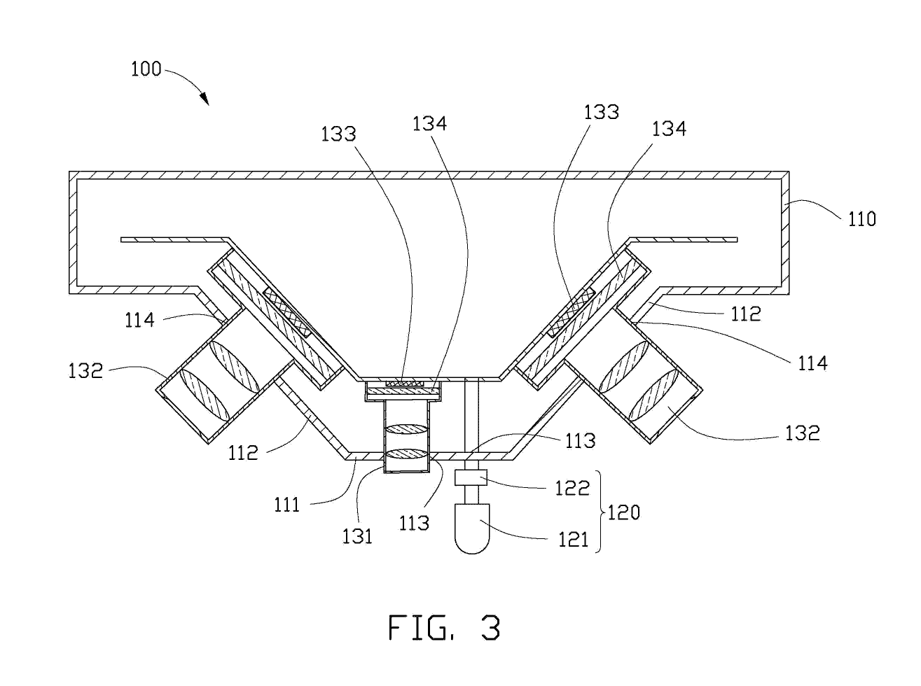

Also referring to FIG. 3, the casing 110 is a hexagonal platform which includes a bottom wall 111 and six inclined sidewalls 112 surrounding the bottom wall 111. The bottom wall 111 defines two first through holes 113. Each inclined sidewall 112 defines a second through hole 114. When the surveillance system 100 is installed on a ceiling (not shown), the casing 110 is inverted and the bottom wall 111 is directed towards a monitored area. The casing 110 can take other shapes and accordingly the numbers of the inclined sidewalls 112 is not limited to six as illustrated in this embodiment. In alternative embodiments, other numbers (e.g. at least three) of the inclined sidewalls 112 may be employed based on what is needed.

The auxiliary light source 120 is disposed on the bottom wall 111 and extends outward from one of the two first through holes 113. The auxiliary light source 120 includes a near-IR emitter 121 and a brightness sensor 122. The near-IR emitter 121 is configured for emitting near-infrared light rays to illuminate the monitored area. The brightness sensor 122 stores a predetermined brightness threshold and configured for sensing a brightness value of the monitored area. The brightness sensor 122 is also configured for generating a controlling signal to turn on the near-IR emitter 121 when the brightness value is lower than the brightness threshold and otherwise turn off the near-IR emitter 121.

The image capturing device 130 is configured for capturing images of the monitored area and includes a first image capturing module 131 and six second image capturing modules 132 (such as a video camera).

The first image capturing module 131 is disposed on the bottom wall 111 and extends outward from the other first through-hole 113, and thus the first image capturing module 131 is positioned at the top of the monitored area, pointing directly to the monitored area. The second capturing modules 132 are disposed on the respective inclined walls 112 and extend from the respective second through hole 114. In this embodiment, the field of view (FOV) of the first image capturing module 131 is larger than 60°. The six second image capturing modules 132 are equidistantly arranged in a circle, and the FOV of the second image capturing module 132 is larger than 60°. Thus the FOV of the first capture module 131 and the two laterally opposite second image capture modules 132 overlap to form a total FOV larger 180°. The numbers of the second image capturing modules 132 are not limited to six as in this embodiment. In other alternative embodiments, other numbers (e.g. at least three) of the second image capturing modules 132 may be employed based on what is needed. However, the FOV of the second image capturing module 132 requires redefinition to ensure the rearranged first image capture module 131 and the laterally opposite two second image capture modules 132 to form a total 180° FOV. In detail, the redefined FOV of the second image capturing module 132 can be determined by dividing 360° by the actual number of the second image capturing modules 132, for example, the FOV of the second image capture module is greater 72° when only five second image capture modules 132 are employed instead.

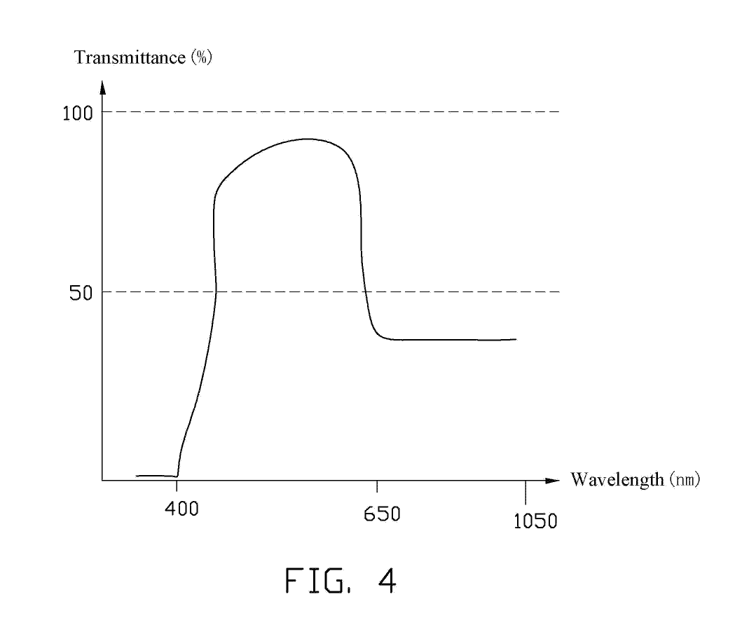

The first image capturing module 131 and the six second image capturing modules 132 each include an image sensor 133 and a filter 134 positioned at an object side of the image sensor 133. Referring to FIG. 4, the transmittance of the filter 134 with respect to visible light (the wavelength is between 400 nm-650 nm) is higher than that of the near-infrared light rays (the wavelength is between 650 nm-1050 nm). Thus, in the daytime, the filter 134 can filter a portion of near-infrared light rays and allow visible light to pass through. Because the refractive index of the near-infrared light rays in a lens of the first, second image capturing module 131, 132 is approximately equal to that of the visible light, the near-infrared light rays that pass through the image capturing device 130 does not affect the imaging quality of the image sensor 133. At night, the near-IR emitter 121 can emit the near-infrared light rays. A portion of the near-infrared light rays can pass through the filter 134.

The auxiliary light source 120, the image capturing device 130, the storing device 140, and the display 150 are electrically connected to each other. The storing device 140 is configured for storing the captured image. The display 150 is configured for displaying the captured image. In this embodiment, the display 150 is divided into seven sections and configured for displaying the images captured by the corresponding image capturing modules respectively. It can be understood that, in other alternative embodiments, the display 150 can display the images captured by the first image capturing module 131 and the six second image capturing modules 132 in turn.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A surveillance system comprising:
an image capturing device comprising:
at least one image capturing module comprising an image sensor and a filter positioned on an object side of the image sensor, wherein the visible light transmittance of the filter is higher than the near-infrared light transmittance of the filter; and
an auxiliary light source comprising:
a near-IR emitter configured for emitting near-infrared light rays to illuminate a monitored area; and
a brightness sensor storing a predetermined brightness threshold and configured for detecting the brightness value of the monitored area and sending a controlling signal to turn on the near-IR emitter when the brightness value is less than the brightness threshold.

2. The surveillance system of claim 1, further comprising a casing defining a plurality of through holes; wherein the image capturing device and the auxiliary light source are received in the casing and extend outward from the through holes respectively.

3. The surveillance system of claim 2, wherein the casing comprises a bottom wall and at least three inclined sidewalls, the bottom wall defines at least one first through hole, each inclined sidewall defines a second through hole; the image capturing device comprises at least one first image capturing module and at least three second image capturing modules, the at least one first image capturing module is positioned on the bottom wall and extends outward from the at least one first through-hole, the second capturing modules are positioned on the respective inclined walls and extend outward from the respective second through holes.

4. The surveillance system of claim 3, wherein the at least three second image capturing modules are equidistantly arranged in a circle.

5. The surveillance system of claim 4, wherein the field of view (FOV) of the second image capturing module can be determined by dividing 360° by the actual number of the second image capturing modules.

6. The surveillance system of claim 5, wherein the FOV of the first image capturing module and two laterally opposite second image capturing module overlap to form a total FOV larger 180°.

7. The surveillance system of claim 1, further comprising a storing device configured for storing images captured by the image capturing device.

8. The surveillance system of claim 1, further comprising a display configured for displaying images captured by the image capturing device.

9. The surveillance system of claim 8, wherein the display is divided into a plurality of regions, and each region is configured for displaying images captured by a corresponding image capturing module.

10. The surveillance system of claim 8, wherein the display displays images captured by the first image capturing module and the at least three second image capturing modules in turn.
